(19) United States
(12) Patent Application Publication
(10) Pub. No.: US 2016/0202868 A1
(43) Pub. Date: Jul. 14, 2016

(54) METHOD AND SYSTEM FOR SCROLLING E-BOOK PAGES

(71) Applicant: Kobo Incorporated, Toronto (CA)

(72) Inventors: Nora PARKER, Toronto (CA); Benjamin LANDAU, Toronto (CA)

(73) Assignee: Kobo Incorporated, Toronto (CA)

(21) Appl. No.: 14/595,506

(22) Filed: Jan. 13, 2015

(51) Int. Cl. G06F 3/0486; G06F 3/0483; G06F 3/0485; G06K 9/20

(52) U.S. Cl. CPC G06F 3/0486; G06K 9/2054; G06F 3/0483; G06F 3/0485

(57) ABSTRACT

A method executed in a processor of a computing device for scrolling pages on an e-book is provided. The method includes receiving a request for page scrolling at a current page being displayed, the current page being one of a plurality of pages, reconstructing the current page by showing at least a part of a secondary page while displaying a part of the current page and in response to user input indicating a request to show the secondary page, displaying the secondary page and not the current page.

### TECHNICAL FIELD

Examples described herein relate to a system and method for displaying content on an e-Reading device.

### BACKGROUND

An electronic personal display is a mobile computing device that displays information to a user. While an electronic personal display may be capable of many of the functions of a personal computer, a user can typically interact directly with an electronic personal display without the use of a keyboard that is separate from or coupled to but distinct from the electronic personal display itself. Some examples of electronic personal displays include mobile digital devices/tablet computers and electronic readers (e-readers) such (e.g., Apple iPad®, Microsoft® Surface™, Samsung Galaxy Tab® and the like), handheld multimedia smartphones (e.g., Apple iPhone®, Samsung Galaxy S®, and the like), and handheld electronic readers (e.g., Amazon Kindle®, Barnes and Noble Nook®, Kobo Aura HD, Kobo Aura H2O and the like).

Some electronic personal display devices are purpose built devices designed to perform especially well at displaying digitally-stored content for reading or viewing thereon. For example, a purpose build device may include a display that reduces glare, performs well in high lighting conditions, and/or mimics the look of text as presented via actual discrete pages of paper. While such purpose built devices may excel at displaying content for a user to read, they may also perform other functions, such as displaying images, emitting audio, recording audio, and web surfing, among others.

There are also numerous kinds of consumer devices that can receive services and resources from a network service. Such devices can operate applications or provide other functionality that links a device to a particular account of a specific service. For example, the electronic reader (e-reader) devices typically link to an online bookstore, and media playback devices often include applications that enable the user to access an online media electronic library (or e-library). In this context, the user accounts can enable the user to receive the full benefit and functionality of the device.

### BRIEF DESCRIPTION OF THE DRAWINGS

The accompanying drawings, which are incorporated in and form a part of this specification, illustrate various embodiments and, together with the Detailed Description, serve to explain principles discussed below. The drawings referred to in this brief description of the drawings should not be understood as being drawn to scale unless specifically noted.

FIG. 1 illustrates a system utilizing applications and providing e-book services on a computing device for transitioning to a page scroll mode of operation, according to an embodiment.

FIG. 2 illustrates example architecture of a computing device for transitioning to a page scroll mode of operation, according to an embodiment.

FIGS. 3A, 3B and 3C illustrate examples of scrolling pages of an e-Book, according to an embodiment.

FIG. 4 illustrates a method of page scroll mode of operation, according to an embodiment.

FIG. 5 illustrates an exemplary computer system for page scrolling, according to an embodiment.

### DETAILED DESCRIPTION

Reference will now be made in detail to embodiments of the subject matter, examples of which are illustrated in the accompanying drawings. While the subject matter discussed herein will be described in conjunction with various embodiments, it will be understood that they are not intended to limit the subject matter to these embodiments. On the contrary, the presented embodiments are intended to cover alternatives, modifications and equivalents, which may be included within the spirit and scope of the various embodiments as defined by the appended claims. Furthermore, in the Description of Embodiments, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

Embodiments include a page scroll mode of operation that enables a user to scroll individual pages or page clusters via circular swipe gesture enacted upon the touch screen display. The circle swipe can be continuous, comprising repeated circles until a target page of the scroll action is reached. In one embodiment, to scroll page clusters, such as by chapters, enact the circular gesture using two fingertips simultaneously (e.g., a dual-point gesture) side-by-side. The rate of scrolling, faster vs. slower, may be controlled in proportion to a speed of the circular swipe gesture. To scroll pages backwards, reverse the circular action to a counterclockwise motion.

### Notation and Nomenclature

Unless specifically stated otherwise as apparent from the following discussions, it is appreciated that throughout the present Description of Embodiments, discussions utilizing terms such as “receiving”, “accessing”, “directing”, “storing”, “disabling”, “suspending”, or the like, often refer to the actions and processes of an electronic computing device/system, such as an electronic reader (“eReader”), electronic personal display, and/or a mobile (i.e., handheld) multimedia device, among others. The electronic computing device/system manipulates and transforms data represented as physical (electronic) quantities within the circuits, electronic registers, memories, logic, and/or components and the like of the electronic computing device/system into other data similarly represented as physical quantities within the electronic computing device/system or other electronic computing devices/systems.

“E-books” are a form of electronic publication content stored in digital format in a computer non-transitory memory, viewable on a computing device with suitable functionality. An e-book can correspond to, or mimic, the paginated format of a printed publication for viewing, such as provided by printed literary works (e.g., novels) and periodicals (e.g., magazines, comic books, journals, etc.). Optionally, some e-books may have chapter designations, as well as content that corresponds to graphics or images (e.g., such as in the case of magazines or comic books). Multi-function devices, such as cellular-telephony or messaging devices, can utilize specialized applications (e.g., specialized e-reading application software) to view e-books in a format that mimics the paginated printed publication. Still further, some devices (sometimes labeled as “e-readers”) can display digitally-stored content in a more reading-centric manner, while also providing, via a user input interface, the ability to manipulate that content for viewing, such as via discrete successive pages.

An “e-reading device,” also referred to herein as an electronic personal display, can refer to any computing device that can display or otherwise render an e-book. By way of example, an e-reading device can include a mobile computing device on which an e-reading application can be executed to render content that includes e-books (e.g., comic books, magazines, etc.). Such mobile computing devices can include, for example, a multi-functional computing device for cellular telephony/messaging (e.g., feature phone or smart phone), a tablet computer device, an ultramobile computing device, or a wearable computing device with a form factor of a wearable accessory device (e.g., smart watch or bracelet, glasswear integrated with a computing device, etc.). As another example, an e-reading device can include an e-reader device, such as a purpose-built device that is optimized for an e-reading experience (e.g., with E-ink displays).

One or more embodiments described herein provide that methods, techniques and actions performed by a computing device are performed programmatically, or as a computer-implemented method. Programmatically means through the use of code or computer-executable instructions. A programmatically performed step may or may not be automatic. For example, in one or more embodiments, a content discovery is provided that uses information of an existing reading/reader statistics page, showing details of their progress through existing lists of e-books (as compiled either by a resource store or assembled by a broader e-reading community or entity.

In one embodiment, reading statistics for a given user/reader are compiled and provide information to the reader such as e-reading session lengths, speed of reading, estimated time to complete remainder of e-book, e-books read, etc. Besides indicating reading progress (ex: You have completed 70% of the Pulitzer Prize shortlist for 2014), there will be a button to help users add remaining titles from the list to their library (“See which titles you're missing”), and enable them to buy title for download via a convenient e-commerce purchase transaction. In one embodiment, the system “learns” what types of books or kinds of books the user is most interested in based on the reading statistics associated with the user.

One or more embodiments described herein may be implemented using programmatic modules or components. A programmatic module or component may include a program, a subroutine, a portion of a program, or software or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through instructions that are executable by one or more processors. These instructions may be carried on a computer-readable medium. Machines shown or described with figures below provide examples of processing resources and computer-readable mediums on which instructions for implementing embodiments described can be carried and/or executed. In particular, the numerous machines shown may include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer programs, or a computer usable carrier medium capable of carrying such a program.

### System and Hardware Description

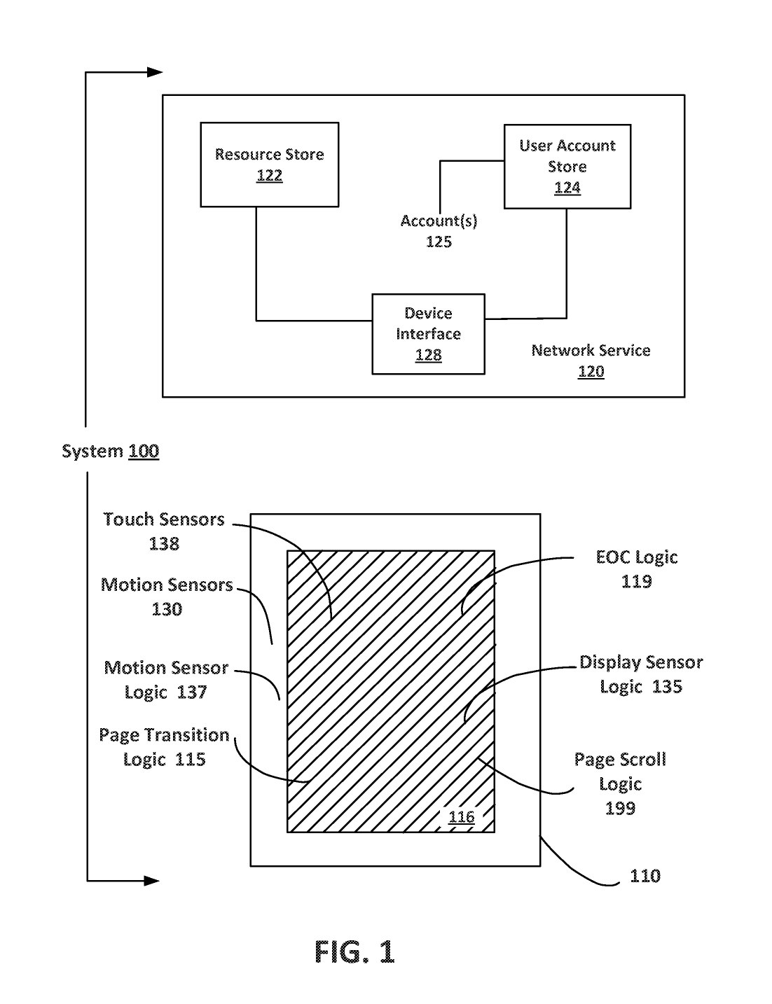

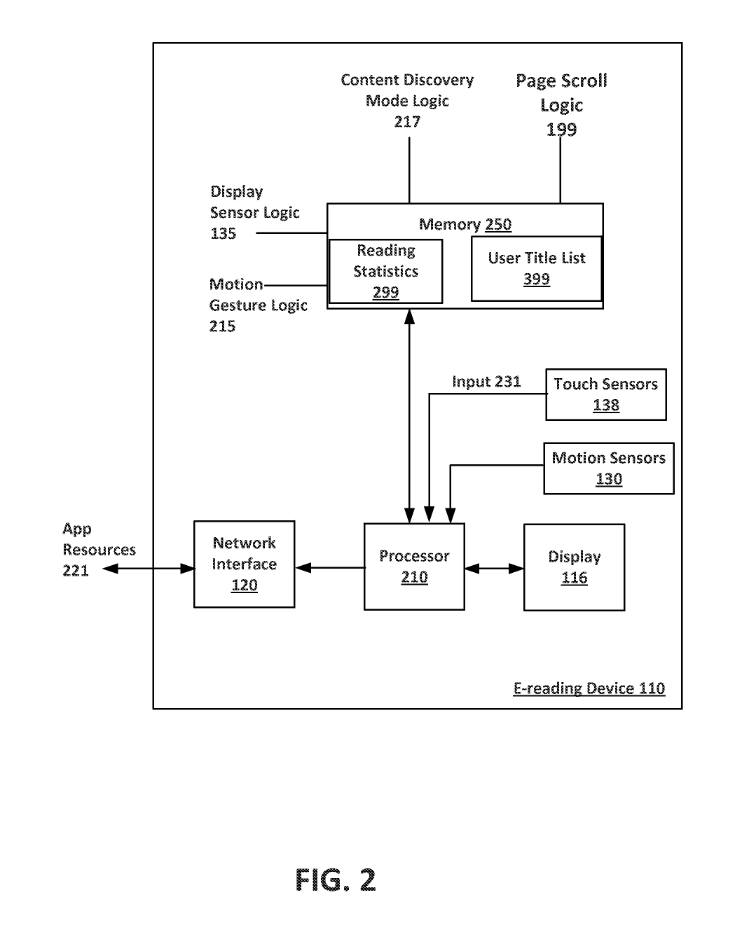

FIGS. 1 and 2 illustrate a system 100 for utilizing applications and providing e-book services on a computing device, according to an embodiment. In an example of FIG. 1, system 100 includes an electronic personal display device, shown by way of example as an e-reading device 110, and a network service 120. The network service 120 can include multiple servers and other computing resources that provide various services in connection with one or more applications that are installed on the e-reading device 110. The device 110 includes page scroll logic 199 for implementing a page scroll mode described herein.

By way of example, in one embodiment, the network service 120 can provide e-book services which communicate with the e-reading device 110. The e-book services provided through network service 120 can, for example, include services in which e-books are sold, shared, downloaded and/or stored. More generally, the network service 120 can provide various other content services, including content rendering services (e.g., streaming media) or other network-application environments or services.

The e-reading device 110 can correspond to any electronic personal display device on which applications and application resources (e.g., e-books, media files, documents) can be rendered and consumed. For example, the e-reading device 110 can correspond to a tablet or telephony/messaging device (e.g., smart phone). In one implementation, for example, e-reading device 110 can run an e-reader application that links the device to the network service 120 and enables e-books provided through the service to be viewed and consumed.

In another implementation, the e-reading device 110 can run a media playback or streaming application that receives files or streaming data from the network service 120. By way of example, the e-reading device 110 can be equipped with hardware and software to optimize certain application activities, such as reading electronic content (e.g., e-books). For example, the e-reading device 110 can have a tablet-like form factor, although variations are possible. In some cases, the e-reading device 110 can also have an E-ink display.

In additional detail, the network service 120 can include a device interface 128, a resource store 122 and a user account store 124. The user account store 124 can associate the e-reading device 110 with a user and with an account 125. The account 125 can also be associated with one or more application resources (e.g., e-books), which can be stored in the resource store 122. The device interface 128 can handle requests from the e-reading device 110, and further interface the requests of the device with services and functionality of the network service 120.

The device interface 128 can utilize information provided with a user account 125 in order to enable services, such as purchasing downloads or determining what e-books and content items are associated with the user device. Additionally, the device interface 128 can provide the e-reading device 110 with access to the content store 122, which can include, for example, an online store. The device interface 128 can handle input to identify content items (e.g., e-books), and further to link content items to the account 125 of the user.

As described further, the user account store 124 can retain metadata for individual accounts 125 to identify resources that have been purchased or made available for consumption for a given account. The c-reading device 110 may be associated with the user account 125, and multiple devices may be associated with the same account. As described in greater detail below, the e-reading device 110 can store resources (e.g., e-books) that are purchased or otherwise made available to the user of the e-reading device 110, as well as to archive e-books and other digital content items that have been purchased for the user account 125, but are not stored on the particular computing device.

With reference to an example of FIG. 1, e-reading device 110 can include a display screen 116. In an embodiment, the display screen 116 is touch-sensitive, to process touch inputs including gestures (e.g., swipes). For example, the display screen 116 may be integrated with one or more touch sensors 138 to provide a touch sensing region on a surface of the display screen 116. For some embodiments, the one or more touch sensors 138 may include capacitive sensors that can sense or detect a human body's capacitance as input. In the example of FIG. 1, the touch sensing region coincides with a substantial surface area, if not all, of the display screen 116. Additionally, a housing can also be integrated with touch sensors to provide one or more touch sensing regions, for example, on the bezel and/or back surface of the housing.

In some embodiments, the e-reading device 110 includes features for providing functionality related to displaying paginated content. The e-reading device 110 can include page transitioning logic 115, which enables the user to transition through paginated content. The e-reading device 110 can display pages from e-books, and enable the user to transition from one page state to another. In particular, an e-book can provide content that is rendered sequentially in pages, and the e-book can display page states in the form of single pages, multiple pages or portions thereof. Accordingly, a given page state can coincide with, for example, a single page, or two or more pages displayed at once. The page transitioning logic 115 can operate to enable the user to transition from a given page state to another page state. In some implementations, the page transitioning logic 115 enables single page transitions, chapter transitions, or cluster transitions (multiple pages at one time).

The page transitioning logic 115 can be responsive to various kinds of interfaces and actions in order to enable page transitioning. In one implementation, the user can signal a page transition event to transition page states by, for example, interacting with the touch sensing region of the display screen 116. For example, the user may swipe the surface of the display screen 116 in a particular direction (e.g., up, down, left, or right) to indicate a sequential direction of a page transition. In variations, the user can specify different kinds of page transitioning input (e.g., single page turns, multiple page turns, chapter turns, etc.) through different kinds of input. Additionally, the page turn input of the user can be provided with a magnitude to indicate a magnitude (e.g., number of pages) in the transition of the page state.

For example, a user can touch and hold the surface of the display screen 116 in order to cause a cluster or chapter page state transition, while a tap in the same region can effect a single page state transition (e.g., from one page to the next in sequence). In another example, a user can specify page turns of different kinds or magnitudes through single taps, sequenced taps or patterned taps on the touch sensing region of the display screen 116.

E-reading device 110 can also include one or more motion sensors 130 arranged to detect motion imparted thereto, such as by a user while reading or in accessing associated functionality. In general, the motion sensor(s) 130 may be selected from one or more of a number of motion recognition sensors, such as but not limited to, an accelerometer, a magnetometer, a gyroscope and a camera. Further still, motion sensor 130 may incorporate or apply some combination of the latter motion recognition sensors.

In an accelerometer-based embodiment of motion sensor 135, when an accelerometer experiences acceleration, a mass is displaced to the point that a spring is able to accelerate the mass at the same rate as the casing. The displacement is then measured thereby determining the acceleration. In one embodiment, piezoelectric, piezoresistive and capacitive components are used to convert the mechanical motion into an electrical signal. For example, piezoelectric accelerometers are useful for upper frequency and high temperature ranges. In contrast, piezoresistive accelerometers are valuable in higher shock applications. Capacitive accelerometers use a silicon micro-machined sensing element and perform well in low frequency ranges. In another embodiment, the accelerometer may be a micro electro-mechanical systems (MEMS) consisting of a cantilever beam with a seismic mass.

In an alternate embodiment of motion sensor 130, a magnetometer, such as a magnetoresistive permalloy sensor can be used as a compass. For example, using a three-axis magnetometer allows a detection of a change in direction regardless of the way the device is oriented. That is, the three-axis magnetometer is not sensitive to the way it is oriented as it will provide a compass type heading regardless of the device's orientation.

In another embodiment of motion sensor 130, a gyroscope measures or maintains orientation based on the principles of angular momentum. In one embodiment, the combination of a gyroscope and an accelerometer comprising motion sensor 135 provides more robust direction and motion sensing.

In yet another embodiment of motion sensor 130, a camera can be used to provide egomotion, e.g., recognition of the 3D motion of the camera based on changes in the images captured by the camera. In one embodiment, the process of estimating a camera's motion within an environment involves the use of visual odometry techniques on a sequence of images captured by the moving camera. In one embodiment, it is done using feature detection to construct an optical flow from two image frames in a sequence.

For example, features are detected in the first frame, and then matched in the second frame. The information is then used to make the optical flow field showing features diverging from a single point, e.g., the focus of expansion. The focus of expansion indicates the direction of the motion of the camera. Other methods of extracting egomotion information from images, method that avoid feature detection and optical flow fields are also contemplated. Such methods include using the image intensities for comparison and the like.

According to some embodiments shown in FIG. 2, the e-reading device 110 includes display sensor logic 135 to detect and interpret user input or user input commands made through interaction with the touch sensors 138. By way of example, the display sensor logic 135 can detect a user making contact with the touch sensing region of the display screen 116. More specifically, the display sensor logic 135 can detect taps, an initial tap held in sustained contact or proximity with display screen 116 (otherwise known as a “long press”), multiple taps, and/or swiping gesture actions made through user interaction with the touch sensing region of the display screen 116. Furthermore, the display sensor logic 135 can interpret such interactions in a variety of ways. For example, each interaction may be interpreted as a particular type of user input corresponding with a change in state of the display 116. The device 110 also includes page scroll logic 199 for implementing a page scroll mode described herein and may couple with the display sensor logic for receiving user inputs via interaction with the display screen.

For some embodiments, the display sensor logic 135 may further detect the presence of water, dirt, debris, and/or other extraneous objects on the surface of the display 116. For example, the display sensor logic 135 may be integrated with a water-sensitive switch (e.g., such as an optical rain sensor) to detect an accumulation of water on the surface of the display 116. In a particular embodiment, the display sensor logic 135 may interpret simultaneous contact with multiple touch sensors 138 as a type of non-user input. For example, the multi-sensor contact may be provided, in part, by water and/or other unwanted or extraneous objects (e.g., dirt, debris, etc.) interacting with the touch sensors 138. Specifically, the e-reading device 110 may then determine, based on the multi-sensor contact, that at least a portion of the multi-sensor contact is attributable to presence of water and/or other extraneous objects on the surface of the display 116.

E-reading device 110 further includes motion gesture logic 137 to interpret user input motions as commands based on detection of the input motions by motion sensor(s) 130. For example, input motions performed on e-reading device 110 such as a tilt, a shake, a rotation, a swivel or partial rotation and an inversion may be detected via motion sensors 130 and interpreted as respective commands by motion gesture logic 137.

E-reading device 110 further includes extraneous object configuration (EOC) logic 119 to adjust one or more settings of the e-reading device 110 to account for the presence of water and/or other extraneous objects being in contact with the display screen 116. For example, upon detecting the presence of water and/or other extraneous objects on the surface of the display screen 116, the EOC logic 119 may power off the e-reading device 110 to prevent malfunctioning and/or damage to the device 110. EOC logic 119 may then reconfigure the e-reading device 110 by invalidating or dissociating a touch screen gesture from being interpreted as a valid input command, and in lieu thereof, associate an alternative type of user interactions as valid input commands, e.g., motion inputs that are detected via the motion sensor(s) 130 will now be associated with any given input command previously enacted via the touch sensors 138 and display sensor logic 135. This enables a user to continue operating the e-reading device 110 even with the water and/or other extraneous objects present on the surface of the display screen 116, albeit by using the alternate type of user interaction.

In some embodiments, input motions performed on e-reading device 110, including but not limited to a tilt, a shake, a rotation, a swivel or partial rotation and an inversion may be detected via motion sensors 130 and interpreted by motion gesture logic 137 to accomplish respective output operations for e-reading actions, such as turning a page (whether advancing or backwards), placing a bookmark on a given page or page portion, placing the e-reader device in a sleep state, a power-on state or a power-off state, and navigating from the e-book being read to access and display an c-library collection of e-books that may be associated with user account store 124.

FIG. 2 illustrates architecture, in one embodiment, of e-reading device 110 as described above with respect to FIG. 1. In one embodiment, the e-reading device provides a content discovery mode 217 that uses information of an existing reading/reader statistics 299, where users will be shown details of their progress through existing title list 399 of e-books (as compiled either by a resource store or assembled by a broader e-reading community or entity. The reading statistics 299 indicate reading progress (ex: You have completed 70% of the Pulitzer Prize shortlist for 2014).

The processor 210 can implement functionality using the logic and instructions stored in the memory 250. Additionally, in some implementations, the processor 210 utilizes the network interface 220 to communicate with the network service 120 (see FIG. 1). More specifically, the e-reading device 110 can access the network service 120 to receive various kinds of resources (e.g., digital content items such as e-books, configuration files, account information), as well as to provide information (e.g., user account information, service requests etc.). For example, e-reading device 110 can receive application resources 221, such as e-books or media files, that the user elects to purchase or otherwise download via the network service 120.

The application resources 221 that are downloaded onto the e-reading device 110 can be stored in the memory 250. In one embodiment, memory 250 comprises a user title list 399 dedicated to storing a list of the content read by the user and may store titles that can be recommended to the user based on the user's reading history and reading statistics 299. In one embodiment, the user title list 399 is generated automatically based on filtering rules set by the user. User title list 399 may also include one or more rules that can be used to generate content discovery.

In some implementations, the display 116 can correspond to, for example, a liquid crystal display (LCD) or light emitting diode (LED) display that illuminates in order to provide content generated from processor 210. In some implementations, the display 116 can be touch-sensitive. For example, in some embodiments, one or more of the touch sensor components 138 may be integrated with the display 116. In other embodiments, the touch sensor components 138 may be provided (e.g., as a layer) above or below the display 116 such that individual touch sensor components 116 track different regions of the display 116. Further, in some variations, the display 116 can correspond to an electronic paper type display, which mimics conventional paper in the manner in which content is displayed. Examples of such display technologies include electrophoretic displays, electrowetting displays, and electrofluidic displays.

The processor 210 can receive input from various sources, including the touch sensor components 138, the display 116, and/or other input mechanisms (e.g., buttons, keyboard, mouse, modules, microphone, etc.). With reference to examples described herein, the processor 210 can respond to input 231 detected at the touch sensor components 138. In some embodiments, the processor 210 responds to inputs 231 from the touch sensor components 138 in order to facilitate or enhance e-book activities such as generating e-book content on the display 116, performing page transitions of the displayed e-book content, powering off the device 110 and/or display 116, activating a screen saver, launching or closing an application, and/or otherwise altering a state of the display 116.

In some embodiments, the memory 250 may store display sensor logic 135 that monitors for user interactions detected through the touch sensor components 138, and further processes the user interactions as a particular input or type of input. In an alternative embodiment, the display sensor logic 135 may be integrated with the touch sensor components 138. For example, the touch sensor components 138 can be provided as a modular component that includes integrated circuits or other hardware logic, and such resources can provide some or all of the display sensor logic 135. In variations, some or all of the display sensor logic 135 may be implemented with the processor 210 (which utilizes instructions stored in the memory 250), or with an alternative processing resource.

In one implementation, the display sensor logic 135 includes detection logic 213 and gesture logic 215. The detection logic 213 implements operations to monitor for the user contacting a surface of the display 116 coinciding with a placement of one or more touch sensor components 138. The gesture logic 215 detects and correlates a particular gesture (e.g., pinching, swiping, tapping, etc.) as a particular type of input or user action. The gesture logic 215 may also detect directionality so as to distinguish between, for example, leftward or rightward swipes.

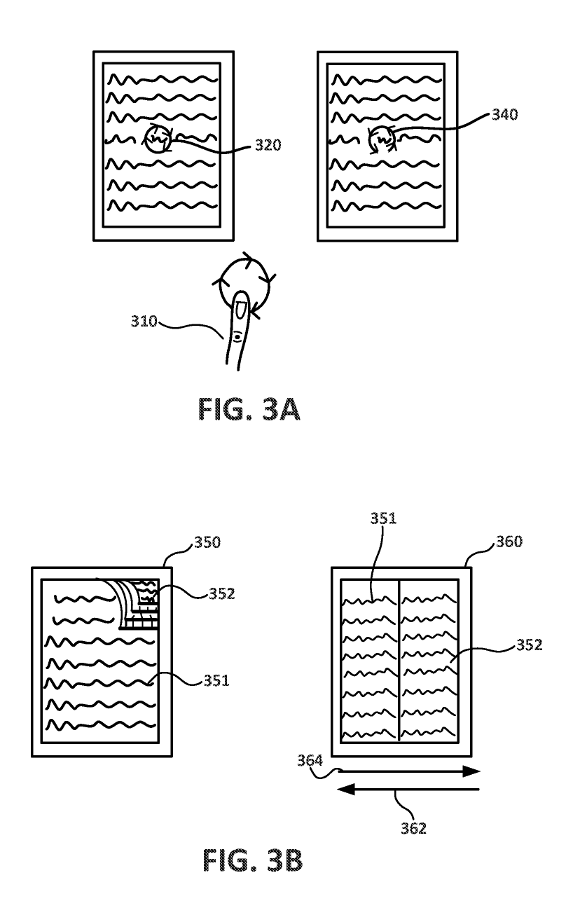

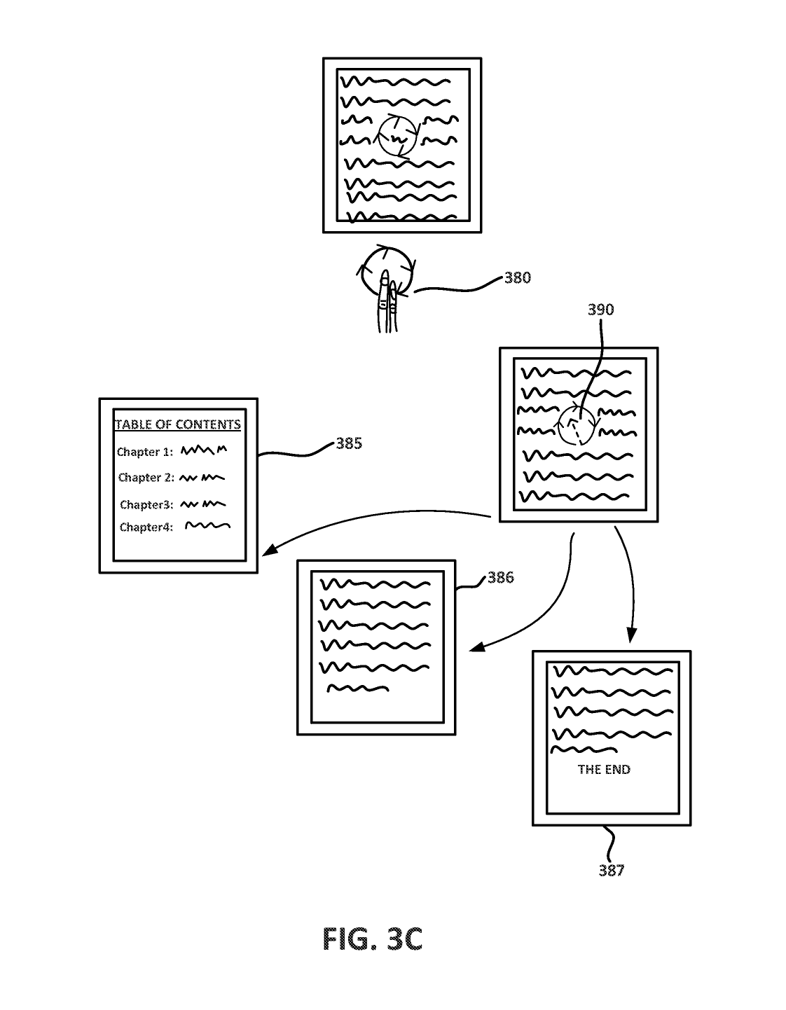

Additionally, the content discovery mode logic 217 may enable a new set of actions to be performed by the e-reading device 110. For example, the content discovery mode logic 217 may take users to a pop-up window, such as user interface (UI) 3240 of FIG. 3 where they can pull content that the user has not read, but may interested in based on the reading history and reading statistics. The content discovery mode logic 217 may also enable a user to generate rules for generating the proposed content. In one embodiment, these rules may reside in memory 250 or user title list 399 and reading history.

For each e-Reader user account, reading statistics 299 for a given user/reader are compiled and provided to the reader such as e-reading session lengths, speed of reading, estimated time to complete remainder of e-book, e-books read, etc. The content discovery mode described herein uses information of an existing reading/reader statistics page, where users will be shown details of their progress through existing lists of e-books (as collected by either by an e-Reader store or assembled by a broader e-reading community or entity).

Besides indicating reading progress (ex: You have completed 70% of the Pulitzer Prize shortlist for 2014), there will be a hot button 145 to help users add remaining titles from the list to their library (“See which titles you're missing”), and enable them to buy title for download via a convenient e-commerce purchase transaction. In one embodiment, a content filter 287 filters the results provided by the content discovery module 399 according to filtering rules set by the user or rules that can be automatically determined based on the user's reading statistics.

To produce these statistics, the user's e-library collection of titles 399 would be compared against a compiled collection list determined by the content discovery module 399 (such as the Pulitzer Prize Shortlist for 2014 example above). Examples of collection lists prepared by an e-Reading service store might include Book of the Month, lists compiled by friends, or lists according to merchandising (ex: Historical Mysteries & Thrillers, Made in Canada, Popular Pre-Orders, New & Hot in Non-Fiction), and top-selling books of different genres. Other collection lists might include award-winning novels (ex: Giller Prize winners, books receiving the Nobel prize in literature, shortlisted books for literary awards), New York Times bestsellers, collections compiled and listed by famous book bloggers, and novels selected by book club curators (ex: Oprah's book club).

In one embodiment, a content discovery scheme is provided that uses information of an existing reading/reader statistics page, where users will be shown details of their progress through existing lists of e-books (as compiled by either by a resource store or assembled by a broader e-reading community or entity to recommend future reading titles. In one embodiment, the content discovery described herein can be used to drive sales of content to the user based on the user's reading history and reading statistics.

The content discovery logic 217 could learn over time, growing more accurate about a reader's interest. In one embodiment, the content discovery logic 217 functions as a media recommendation system that uses reading stats to evaluate what category/genre of a book a user is more eager to finish. In one embodiment, the determination is based on a user's time spent reading particular media.

The content discovery logic, in one embodiment, places more weight on books the user returns to (even if in short sessions) more often and finishes and places less weight on books with slow reading time/longer delays between reading sessions.

For example, books with long reading sessions and fast pages/minute reading speed are weighted most highly and books with short reading sessions and fast pages/minute reading speed could have equal weight (a user may have a hectic lifestyle).

Optionally, educational/work related books (categories marked by a user in app settings) could be excluded from this specific weighing system. In a variation, the recommendation system could offer a “Try something new” recommendation that is of the less-tried/slower-read categories.

FIGS. 3A, 3B and 3C illustrate examples of a page scroll logic module 199 for scrolling pages of an e-Book, according to an embodiment.

Embodiments include a page scroll logic module 199 that can be used to aid in scrolling pages of an e-Book. The page scroll logic module 199 described herein enables a user to scroll individual pages or page clusters via circular swipe gesture enacted upon the touch screen display.

The circle swipe can be continuous, comprising repeated circles until a target page of the scroll action is reached. In one embodiment, to scroll page clusters, such as by chapters, enact the circular gesture using two fingertips simultaneously (e.g., a dual-point gesture) side-by-side. The rate of scrolling, faster vs. slower, may be controlled in proportion to a speed of the circular swipe gesture. To scroll pages backwards, reverse the circular action to a CCW motion.

FIG. 3A shows a single finger circle swipe gesture 310 that can be used to activate a page scrolling mode of operation. A user swipes in a clockwise direction 320 to scroll from a current page to a subsequent page. The circular gesture can be performed any place on the display to initiate the page scroll mode of operation described herein.

Once the page scroll mode is activated, a user can control the speed and advancement using their finger. For example, the faster the circle is performed, the faster the pages scroll. In one embodiment, a clockwise circle 320 is used for advancing pages and a counter clockwise circle 340 can be used to scrolling back pages.

The scrolling can be displayed several ways, as shown in FIG. 3B. For example, scrolling could be displayed as if a user were flipping through a book 350 where a current page 351 and secondary pages 352 are shown as if a user were flipping through the pages.

In another embodiment, the scrolling is displayed such that pages move to the left 362 or right 364 across the screen. In this embodiment, a current page 351 and a secondary page 352 are shown as if physically sliding the pages across the display.

FIG. 3C shows an embodiment of page scrolling using more than one finger to perform the scroll gesture. In one embodiment, the same circular gesture as described in above can be performed with two fingers simultaneously to perform a variation of page scrolling for scrolling chapters, for example. As with the single finger circle gesture, a two finger circle gesture 380 can be performed in a clockwise or counterclockwise direction to scroll chapter by chapter.

In one embodiment, once page scroll mode is initiated using two fingers, a user can tap 390 in the center of the circle to automatically take the user to the table of contents page 385 of an e-Book. Two taps could bring the user to the end of the current chapter 386 and three taps could bring the user to the end of the book 387, for example. In one embodiment, the actions performed by tapping during a page scroll mode can be customized by the user.

### Methodology

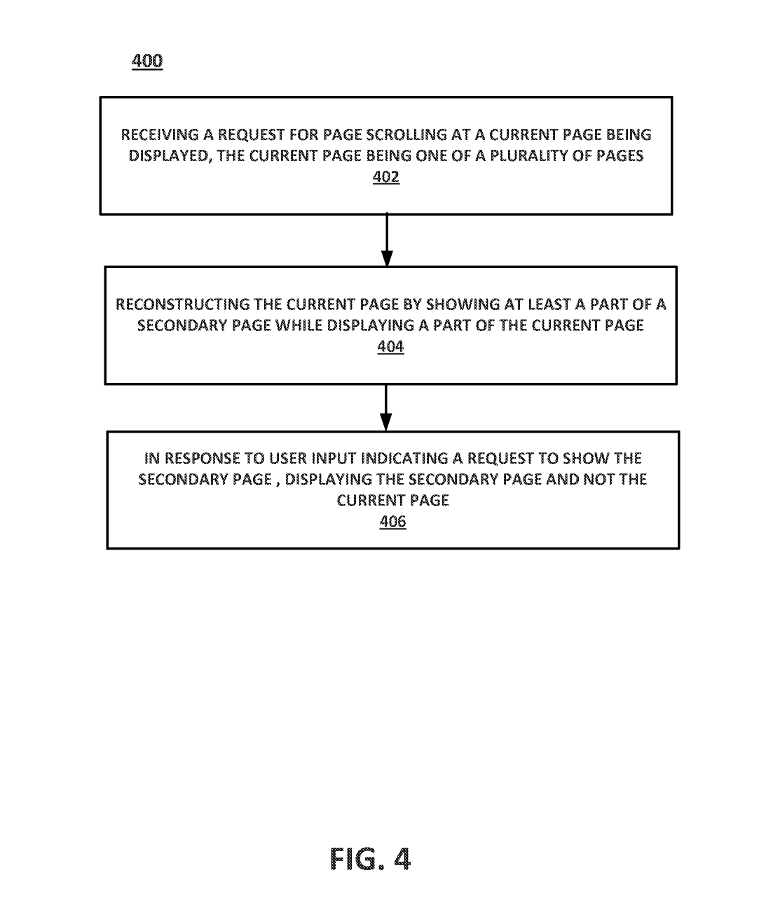

FIG. 4 illustrates a method 400 of providing a page scroll mode of operation of an e-Reader, according to one or more embodiments. In describing the example of FIG. 4, reference may be made to components such as described with FIGS. 1, 2 and 3A, 3B and 3C for purposes of illustrating suitable components and logic modules for performing a step or sub-step being described.

With reference to the example of FIG. 4, at 402, method 400 includes receiving a request for page scrolling at a current page being displayed, the current page being one of a plurality of pages. For example, the reader begins by performing a circular motion gesture using one or more fingers. The circular motion gesture can be performed in a clockwise direction to scroll up ahead and a counterclockwise direction can be used to scroll back.

At 404, method 400 includes reconstructing the current page by showing at least a part of a secondary page while displaying a part of the current page. For example, in FIG. 3B, pages are scrolled as if the pages were being turned or as if they were being dragged across the page.

At 406, method 400 includes in response to user input indicating a request to show the secondary page, displaying the secondary page and not the current page. For example, as the reader scrolls forward or back, when the desired page is located, removing the finger from the display causes the e-Reader to display the scrolled page.

### Example Computer System Environment

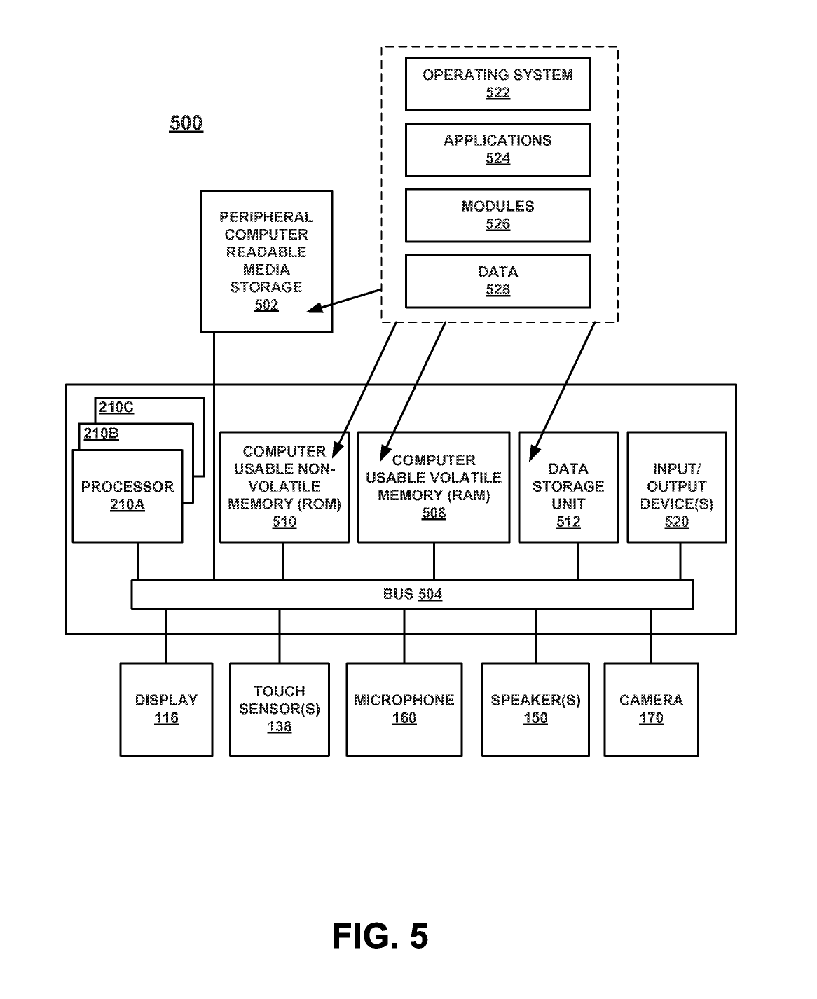

With reference now to FIG. 5, all or portions of some embodiments described herein are composed of computer-readable and computer-executable instructions that reside, for example, in computer-usable/computer-readable storage media of a computer system. That is, FIG. 5 illustrates one example of a type of computer (computer system 500) that can be used in accordance with or to implement various embodiments of an e-Reader, such as e-Reader 100, which are discussed herein. It is appreciated that computer system 500 of FIG. 5 is only an example and that embodiments as described herein can operate on or within a number of different computer systems.

System 500 of FIG. 5 includes an address/data bus 504 for communicating information, and a processor 210A coupled to bus 504 for processing information and instructions. As depicted in FIG. 5, system 500 is also well suited to a multi-processor environment in which a plurality of processors 210A, 210B, and 210C are present. Processors 210A, 210B, and 210C may be any of various types of microprocessors. For example, in some multi-processor embodiments, one of the multiple processors may be a touch sensing processor and/or one of the processors may be a display processor. Conversely, system 500 is also well suited to having a single processor such as, for example, processor 210A.

System 500 also includes data storage features such as a computer usable volatile memory 508, e.g., random access memory (RAM), coupled to bus 504 for storing information and instructions for processors 210A, 210B, and 210C. System 500 also includes computer usable non-volatile memory 510, e.g., read only memory (ROM), coupled to bus 504 for storing static information and instructions for processors 210A, 210B, and 210C. Also present in system 500 is a data storage unit 512 (e.g., a magnetic or optical disk and disk drive) coupled to bus 504 for storing information and instructions.

Computer system 500 of FIG. 5 is well adapted to having peripheral computer-readable storage media 502 such as, for example, a floppy disk, a compact disc, digital versatile disc, universal serial bus “flash” drive, removable memory card, and the like coupled thereto. In some embodiments, computer-readable storage media 502 may be coupled with computer system 500 (e.g., to bus 504) by insertion into removable a storage media slot.

System 500 also includes or couples with display 116 for visibly displaying information such as alphanumeric text and graphic images. In some embodiments, system 500 also includes or couples with one or more optional touch sensors 138 for communicating information, cursor control, gesture input, command selection, and/or other user input to processor 210A or one or more of the processors in a multi-processor embodiment. In some embodiments, system 500 also includes or couples with one or more optional speakers 150 for emitting audio output. In some embodiments, system 500 also includes or couples with an optional microphone 160 for receiving/capturing audio inputs. In some embodiments, system 500 also includes or couples with an optional digital camera 170 for receiving/capturing digital images as an input.

Optional touch sensor(s) 230 allows a user of computer system 500 (e.g., a user of an eReader of which computer system 500 is a part) to dynamically signal the movement of a visible symbol (cursor) on display 116 and indicate user selections of selectable items displayed. In some embodiment other implementations of a cursor control device and/or user input device may also be included to provide input to computer system 500, a variety of these are well known and include: trackballs, keypads, directional keys, and the like.

System 500 is also well suited to having a cursor directed or user input received by other means such as, for example, voice commands received via microphone 160. System 500 also includes an input/output (I/O) device 520 for coupling system 500 with external entities. For example, in one embodiment, I/O device 520 is a modem for enabling wired communications or modem and radio for enabling wireless communications between system 500 and an external device and/or external network such as, but not limited to, the Internet. I/O device 520 may include a short-range wireless radio such as a Bluetooth® radio, Wi-Fi radio (e.g., a radio compliant with Institute of Electrical and Electronics Engineers' (IEEE) 802.11 standards), or the like.

Referring still to FIG. 5, various other components are depicted for system 500. Specifically, when present, an operating system 522, applications 524, modules 526, and/or data 528 are shown as typically residing in one or some combination of computer usable volatile memory 408 (e.g., RAM), computer usable non-volatile memory 510 (e.g., ROM), and data storage unit 512. For example, modules 526 may include various application modules such as a receiving module for receiving a request to enter a scrolling mode from a user, an accessor module for accessing a reading history related to the user, a reading statistics module for gathering and storing user reading histories and reading statistics, a user title list module for maintaining a user title list and possible discovered titles, a content filter module for filtering titles according to filtering rules, a content management module for managing a library for a user and a content purchasing module for completing financial transactions associated with adding content to the user's library.

In some embodiments, all or portions of various embodiments described herein are stored, for example, as an application 524 and/or module 526 in memory locations within RAM 508. ROM 510, computer-readable storage media within data storage unit 512, peripheral computer-readable storage media 502, and/or other tangible computer readable storage media.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments.

What is claimed is:

1. A method executed in a processor of a computing device, the computing device further including a memory storing instructions and a first display screen rendering e-book content including text formatted according to a series of digitally constructed pages, the method comprising:
receiving a request for content relocation at a current page being displayed on said first display screen, the current page having a first text portion;
reconstructing the current page by highlighting at least a part of said first text portion; and
in response to user input indicating a request to move the highlighted content, displaying at least a part of said first text portion on a second display screen.

2. The method of claim 1 wherein said user indicates said request to move said highlighted content by dragging said highlighted content to a side edge of the current page as displayed on the first display screen.

3. The method of claim 1 further comprising:
modifying a font of said first text portion in response to said highlighting.

4. The method of claim 1 wherein said user input indicating a request to move the highlighted content to said second display screen includes holding a finger on a side portion of said second display screen.

5. The method of claim 4 wherein said holding is performed for more than one second.

6. The method of claim 1 further comprising:
receiving indication said user selected a hot button requesting said highlighted content to be shown.

7. The method of claim 1 wherein said first and second display screens are integrated within said computing device.

8. A computer-readable medium that stores instructions for a computing device, the computing device including a processor, a memory and a first display screen rendering e-book content including text formatted according to a series of digitally constructed pages, the instructions being executable by the processor to cause the computing device to perform operations that include:
receiving a request for content relocation at a current page being displayed on said first display screen, the current page having a first text portion;
reconstructing the current page by highlighting at least a part of said first text portion; and
in response to user input indicating a request to move the highlighted content, displaying at least a part of said first text portion on a second display screen.

9. The computer-readable medium of claim 8 wherein said user indicates said request to move said highlighted content by dragging said highlighted content to a side edge of the current page as displayed on the first display screen.

10. The computer-readable medium of claim 8 wherein said operations further include:
modifying a font of said first text portion in response to said highlighting.

11. The computer-readable medium of claim 8 wherein said user input indicating a request to move the highlighted content to said second display screen includes holding a finger on a side portion of said second display screen.

12. The computer-readable medium of claim 11 wherein said holding is performed for more than one second.

13. The computer-readable medium of claim 8 wherein said operations further include:
receiving indication said user selected a hot button requesting said highlighted content to be shown.

14. The computer-readable medium of claim 8 wherein said first and second display screens are integrated within said computing device.

15. A computing device comprising:
a memory that stores a set of instructions;
a first and a second display screen rendering e-book content including text formatted according to a series of digitally constructed pages;
a processor that access the instructions in memory, the processor further configured to:
receiving a request for content relocation at a current page being displayed on said first display screen, the current page having a first text portion;
reconstructing the current page by highlighting at least a part of said first text portion; and
in response to user input indicating a request to move the highlighted content, displaying at least a part of said first text portion on a second display screen.

16. The computing device of claim 15 wherein said user indicates said request to move said highlighted content by dragging said highlighted content to a side edge of the current page as displayed on the first display screen.

17. The computing device of claim 15 wherein said processor is further configured to:
modify font of said first text portion in response to said highlighting.

18. The computing device of claim 15 wherein said user input indicating a request to move the highlighted content to said second display screen includes holding a finger on a side portion of said second display screen.

19. The computing device of claim 18 wherein said holding is performed for more than one second.

20. The computing device of claim 15 wherein said processor is further configured to:
receive indication said user selected a hot button requesting said highlighted content to be shown.

21. The computing device of claim 15 wherein said first display screen is on a front side of said computing device and said second display screen is on a back side of said computing device.
